(19) United States
(12) Patent Application Publication
(10) Pub. No.: US 2025/0145443 A1
(43) Pub. Date: May 8, 2025

(54) SUSTAINABLE METHOD FOR COMPOUNDING FLAVOURS AND FRAGRANCES

(71) Applicant: GIVAUDAN SA, VERNIER (CH)

(72) Inventors: Mike CULLEN, Ashford (GB); Ollivier ROUSTAN, VERNIER (CH)

(21) Appl. No.: 18/837,462

(22) PCT Filed: Feb. 6, 2023
(86) PCT No.: PCT/EP2023/052864

§ 371 Date: Aug. 9, 2024

Related U.S. Application Data
(60) Provisional application No. 63/309,104, filed on Feb. 11, 2022.

(51) Int. Cl. B67C 3/30; B01F 23/70; B01F 35/45; B01F 35/51; B01F 101/06; B01F 101/21; G06Q 10/0835; G06Q 30/0601

(52) U.S. Cl. CPC B67C 3/30; B01F 23/708; B01F 35/45; B01F 35/51; G06Q 10/0835; G06Q 30/0621; B01F 2101/06; B01F 2101/21

(57) ABSTRACT

A method of compounding a flavour or fragrance composition in a single container that is configured to be directly transported to a customer. The method includes i) adding all ingredients of the flavour or fragrance composition to the container, ii) mixing the ingredients added to the container to prepare a compounded flavour or fragrance composition that is ready to ship to a customer, and iii) closing the container to form a water-tight seal.

### TECHNICAL FIELD

The present disclosure relates to a sustainable method for compounding flavours and fragrances.

### BACKGROUND

Flavours and fragrances are the essential ingredients that lend taste and smell to edible compositions and all manner of articles of commerce, such as personal care products, household care products, air-care products and laundry care products.

Typically, flavours and fragrances are a combination of many different ingredients. In general, the term “compounding” refers to the preparation of a flavour or fragrance composition. Current methods for compounding flavours and fragrances require the use of multiple, different containers at various steps of the compounding process. The contents of the multiple, different containers are then combined into a master vessel wherein the ingredients are subjected to a mixing operation or step. The contents of the master mixing vessel are then transferred to a final shipping container that is packaged and transported to a customer.

Such compounding methods that utilize multiple, different containers at various intermediate steps decrease productivity as they require a laborious amount of container handling and cleaning, pump and hose cleaning, and packing time. In addition, such methods are not economical as they produce a significant amount of leftover or residual waste material in each container, and they also require the assembly of expensive packing workstations that prepare the final container for transporting to a customer. Moreover, such methods are wasteful as they require the use of a large amount of single-use plastic packages, and consume a large amount of electricity, water and cleaning agents. Accordingly, there remains a need for a sustainable, cost-effective and environmentally friendly method for compounding flavours and fragrances on a production scale.

### SUMMARY

In a first illustrative aspect, provided is a method of compounding a flavour or fragrance composition in a single container that is configured to be directly transported to a customer, the method includes the steps of i) adding all ingredients of the flavour or fragrance composition to the container; ii) mixing the ingredients in the container; and iii) closing the container to form a water-tight seal.

In a second illustrative aspect, provided is a method of compounding a flavour or fragrance composition in a single container that is configured to be directly transported to a customer, wherein the single container comprises a removable top portion, the method includes the steps of i) removing the top portion of the container; ii) adding all ingredients of the flavour or fragrance composition to the container; iii) mixing the ingredients in the container; and iv) closing the top portion of the container to form a water-tight seal.

### BRIEF DESCRIPTION OF THE DRAWINGS

FIG. 1 is an illustrative side-by-side comparison of a conventional (top) and inventive (bottom) method of compounding flavour and fragrance compositions.

FIG. 2 is an illustrative schematic of the disclosed method of compounding flavour and fragrance compositions.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art.

Disclosed is a novel method for compounding flavour or fragrance compositions that utilizes a single container, sometimes referred to as a “final pack”. The single container is used at each step of the method. In certain embodiments, one or more steps of the disclosed method include a different workstation. In certain embodiments, each step of the disclosed method includes a different workstation. In certain embodiments, the single container is utilized at each workstation from start to finish, including a direct mixing step in the single container.

Provided is a method of compounding a flavour or fragrance composition in a single container that is configured to accommodate the addition into the container of one or more flavour or fragrance ingredients that are required to prepare a desired flavour or fragrance composition, to carry out one or more compounding or mixing operations directly within the container to compound the one or more flavour or fragrance ingredients together to prepare the desired flavour or fragrance composition, and to be closed to hermetically seal the prepared flavour or fragrance composition within the container and transported to a customer. This eliminates the need to use multiple, different containers at various intermediate stages of a flavour or fragrance compounding process, and then subsequently mixing the flavour or fragrance composition ingredients in a separate container, and further subsequently transferring the prepared flavour or fragrance composition to a different shipping container for transport to the customer.

According to a first illustrative embodiment, the method comprises i) adding all ingredients of the flavour or fragrance composition to a single container; ii) mixing the ingredients in the single container; and iii) closing the container to form a water-tight seal.

According to a second illustrative embodiment, the method further comprises transporting the closed container to a customer after the closing step.

According to a third illustrative embodiment, the method comprises the steps of i) removing a removable top portion of the container; ii) adding all ingredients of the flavour or fragrance composition to the container; iii) mixing the ingredients in the container; and iv) closing the removable top portion of the container to form a water-tight seal.

According to a fourth illustrative embodiment, the method further comprises transporting the closed container to a customer after the step of closing the removable top portion of the container.

According to certain illustrative embodiments, the step of closing the container comprises hermetically sealing the container.

According to certain illustrative embodiments, the method further comprises filtering the ingredients of the flavour or fragrance composition before adding the ingredients to the container.

According to certain illustrative embodiments, the method does not include a packing step in which the compounded flavour or fragrance composition is transferred from a compounding vessel to a shipping container.

According to certain illustrative embodiments, the method comprises i) adding all ingredients required to prepare a flavour or fragrance composition to a single container; ii) mixing the ingredients added to the single container to prepare a compounded flavour or fragrance composition that is ready to ship to a customer; iii) closing the single container to form a water-tight seal; and iv) transporting the single container with the prepared flavour or fragrance composition therein.

According to certain illustrative embodiments, the method comprises i) taking an order from a customer for a flavour or fragrance composition; ii) adding all ingredients required to prepare the flavour or fragrance composition into a single container; iii) mixing the ingredients added to the single container to prepare a compounded flavour or fragrance composition that is ready to ship to a customer; iv) closing the single container to form a water-tight seal; and v) transporting the single container with the prepared flavour or fragrance composition therein.

The single container may be manufactured from a variety of materials and may be any shape or size. According to certain illustrative embodiments, the container comprises substantially cylindrical walls closed at the bottom end. According to certain illustrative embodiments, the container comprises a metal drum. According to certain illustrative embodiments, the container has a maximum volumetric capacity ranging from about 5 gallons to about 55 gallons. The single container may be manufactured from metals, metal alloys, polymers, and composite materials. According to certain illustrative embodiments, the single container is manufactured from a metal alloy, such as steel.

The disclosed compounding method improves efficiency and productivity as it significantly reduces the need for multiple, separate compounding vessels at various intermediate stages of the compounding process, decreases container handling and cleaning, eliminates the use of pumps and hoses required to transfer ingredients of a flavour or fragrance compositions between multiple vessels during a traditional compounding method, and also eliminates a packing step that involves the transfer of the final compounded composition from a compounding vessel to a shipping vessel.

The disclosed compounding method is also cost-effective as it significantly reduces residual waste material in different containers, and avoids the assembly of expensive packing workstations and operators.

The disclosed compounding method is also environmentally friendly as it eliminates single-use plastics, and significantly reduces consumption of electricity, water, and cleaning agents.

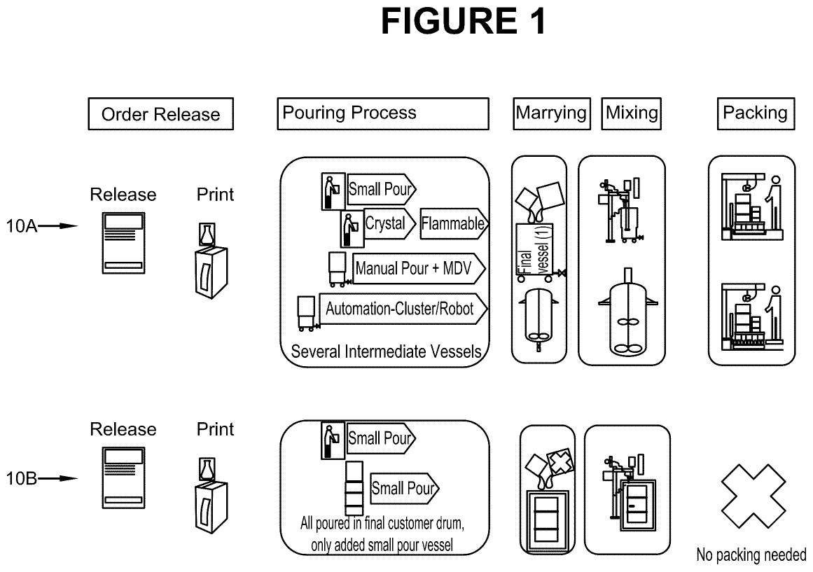

FIG. 1 is an illustrative side-by-side comparison of a conventional 10A and inventive 10B method of compounding flavour and fragrance compositions.

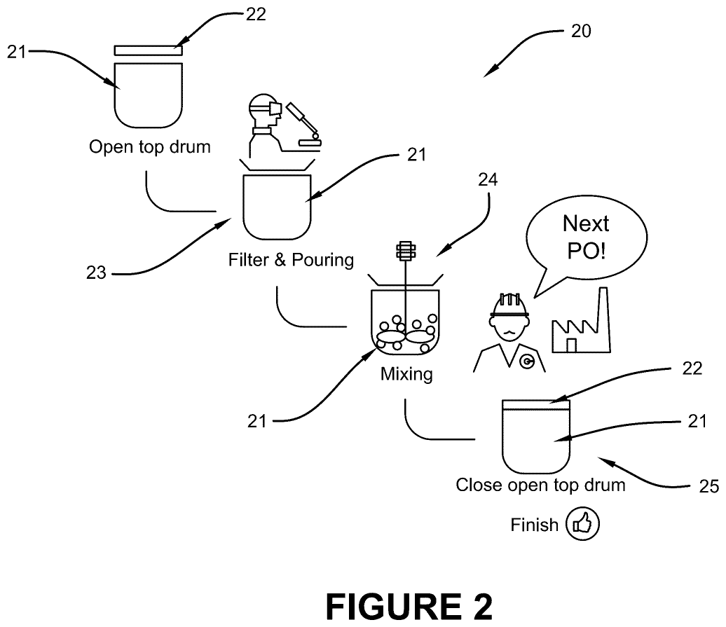

FIG. 2 is a schematic representation of the process flow for an illustrative embodiment of the disclosed method 20. Method 20 utilizes a single cylindrical container or shipping drum 21 having a removable top 22. At step 23 of the method, all of the ingredients required to prepare a compounded flavour or fragrance composition are filtered and then added to the container 21. The flavour or fragrance composition ingredients added to container 21 are mixed together at step 24 of method 20. After suitable mixing has been carried out on the ingredients within the container 21 the container 21 is closed at method step 25 by sealing the removable top 22 to the upper end of the container 21. According to other embodiments, in the event that container 21 is provided to the flavour or fragrance compounder with the removable top 22 affixed to container 21, then in an optional step prior to pouring step 23 the removable top 22 is removed from the container 21.

1. A method of compounding a flavour or fragrance composition in a single container that is configured to be directly transported to a customer, the method comprises the steps of:
i. adding all ingredients of the flavour or fragrance composition to the container;
ii. mixing the ingredients in the container; and
iii. closing the container to form a water-tight seal.

2. The method according to claim 1, further comprising transporting the container to a customer after step (iii).

3. The method according to claim 1, further comprising filtering the ingredients of the flavour or fragrance composition before adding the ingredients to the container.

4. The method according to claim 1, wherein the method does not include a packing step wherein the compounded flavour or fragrance composition is transferred from a compounding vessel to a shipping container.

5. The method according to claim 1, wherein the container comprises substantially cylindrical walls closed at the a bottom end.

6. The method according to claim 1, wherein the container comprises a removable top portion.

7. The method according to claim 6 further comprising removing the top portion of the container prior to step (i).

8. The method according to claim 6, wherein step (iii) comprises closing the top portion of the container to form a water-tight seal.

9. The method according to claim 1, wherein the container comprises a metal drum.

10. The method according to claim 1, wherein step (iii) hermetically seals the container.
